(19) United States
(12) Patent Application Publication
(10) Pub. No.: US 2008/0126931 A1
(43) Pub. Date: May 29, 2008

(54) SYSTEM AND METHOD FOR RECORDING AND REPRODUCING USER OPERATION

(76) Inventors: Gou Kojima, Yamato (JP); Ryoichi Ueda, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/933,610

(22) Filed: Nov. 1, 2007

(30) Foreign Application Priority Data
Nov. 2, 2006 (JP) 2006-298353

(51) Int. Cl. G06F 3/01

(52) U.S. Cl. 715/704

(57) ABSTRACT

Systems and methods for recording and reproducing a user operation performed by a web browser on a web page or a content of a background communication are provided. Functions of recording and reproducing the content of background communication are realized by providing a function of modifying an object for the background communication to record and reproduce the content of the background communication. Processing for reproducing a movement of a mouse cursor, which is not provided as a basic function, is realized by displaying a pseudo mouse cursor using an image and the like on a web page. As for reproducing a keyboard operation, which is not provided as the basic function either, the reproducing processing is realized by a function of generating a script which analyzes a web page to detect an event handler set to respond to a keyboard event, creates an object which has the same information as the recorded keyboard event, and passes the created object to the detected event handler as its argument to execute the event handler.

### BACKGROUND OF THE INVENTION

1. Field of the Invention

The present invention relates to a web application management technique which enables a user operation using a Web browser on a web page provided by a web application to be recorded and reproduced.

2. Description of the Related Art

An application service which uses the web as a user interface is provided in a network such as the Internet. By using the web, a dedicated client program does not have to be prepared to execute each application, and various applications using the web can be used if only there exists a web browser.

A Technique and product for recording and reproducing a user operation on the web have been developed for the purposes such as explanation of how to use an application on the web, checking user operations on the web application, and testing an operation of the web application during development, because the web application has been widely used.

In these techniques, however, an existing web page may have to be modified, or dedicated software for recording and reproducing an operation may need to be installed in a user's system environment.

Japanese Laid open Patent Application No. 2000-76266 discloses such a system for recording and reproducing an operation on a web browser in which dedicated software does not have to be installed other than the web browser in a user's system environment. This system records and reproduces the user operation on the web browser by inserting programs using Java Applet and JavaScript for recording and reproducing an event generated by an operation on the web into sources of a web page. In accordance with this system, the function of recording and reproducing a user operation on a web browser can be provided without installation of the dedicated software other than the web browser in the user's system environment as well as modification of the existing web page.

In the technique disclosed in Japanese Laid open Patent Application No. 2000-76266; however, processing time to start a program for recording and reproducing is long because the technique uses Java Applet.

Japanese Laid open Patent Application No. 2000-76266 does not describe a method for reproducing a recorded event in detail. For example, Japanese Laid open Patent Application No. 2000-76266 does not describe a method for realizing reproduction processing of a movement of a mouse cursor and a keyboard operation which is generally irrealizable by JavaScript.

Japanese Laid open Patent Application No. 2000-76266 does not describe the recording and reproduction processing of a background communication function performed by JavaScript (Hyper Text Transfer Protocol (HTTP) communication function by XMLHttpReq object). Thus, the processing using the background communication generated by a user operation can not be reproduced either.

### SUMMARY OF THE INVENTION

The present invention is made in view of the above problems. An object of the present invention is to provide a user operation recording and reproducing system for reproducing an operation related to an event that JavaScript does not support for reproduction and background communication processing without installation of dedicated software in a user's system environment.

In the present invention, the background communication function of a script a web browser reads may be used. In the present invention, a script for reproducing an operation performed by the web browser may be generated, and the user operation on the web browser may be reproduced by the generated script.

To record a user operation, a web browser may record information on an event generated by a user operation on the web browser, and send the recorded information on the event to a web server with a background communication function of a script the web browser reads. Then, the web server may record the information on the event received from the web browser.

To reproduce a user operation, a web server may generate the script for reproducing a record of the user operation performed by a web browser on a web page and the user operation performed by the web browser on the web page which is recorded in the record of the user operation based on the web page, and send the generated script to the web browser. The web browser receives the script and then executes the received script to reproduce the user operation performed by the web browser on the web page.

In accordance with the user operation recording and reproducing methods of the present invention, it is possible to provide a web page capable of recording and reproducing a user operation on a browser by using only JavaScript utilizing the background communication function (function of XMLHttpRequest object) of JavaScript, for example. As for a reproduction of a movement of a mouse cursor that JavaScript does not support, its reproduction function can be provided by displaying a pseudo mouse cursor made of an image and the like on the web page. As for a reproduction of a keyboard operation that JavaScript does not support, its reproduction function can be provided by a function generating a script that analyzes the web page to detect an event handler set for a keyboard event, creating an object having the same information as that of the recorded keyboard event, and passing the created object, which is a substitute for the keyboard event, to the detected event handler as its argument to execute the event handler. As for recording processing of a background communication, an object (XMLHttpRequest object) which provides the background communication function is modified to add a function of recording a content of the background communication to the object, whereby the function of recording the content of the background communication, which is similar to the recording of the user operation, can be provided. As for a reproduction of the background communication, its reproduction function can be provided by a function generating a script that modifies the object (XMLHttpRequest object) which provides the background communication function to reproduce a recorded communication content instead of performing the background communication with a server as if the background communication was performed.

### BRIEF DESCRIPTION OF THE DRAWINGS

FIG. 1 is a block diagram of an embodiment.

FIG. 2 is an illustration of information flows of user operation recording process.

FIG. 3 shows an example of a web page which makes a web browser to refer to an operation log acquiring and sending script.

FIG. 4 is a flowchart of user operation recording processing according to the embodied script.

FIG. 5 shows an example of a script which modifies the XMLHttpRequest object such that a content of background communication is recorded as an operation log according to the embodied script.

FIG. 6 shows an example of operation log information which is recorded by the operation log acquiring and sending script.

FIG. 7 is an illustration of information flows of a user operation reproducing function according to the embodied script.

FIG. 8 is a flowchart of processing for generating an operation reproducing script according to the embodied script.

FIG. 9 shows an example of a script which performs initializing processing of operation reproduction processing.

FIG. 10 shows an example of a script which performs reproducing processing of events in the operation reproduction processing.

FIG. 11 is a block diagram of a modification.

### BEST MODES FOR CARRYING OUT THE INVENTION

An embodiment of the present invention is now described with reference to the accompanying drawings.

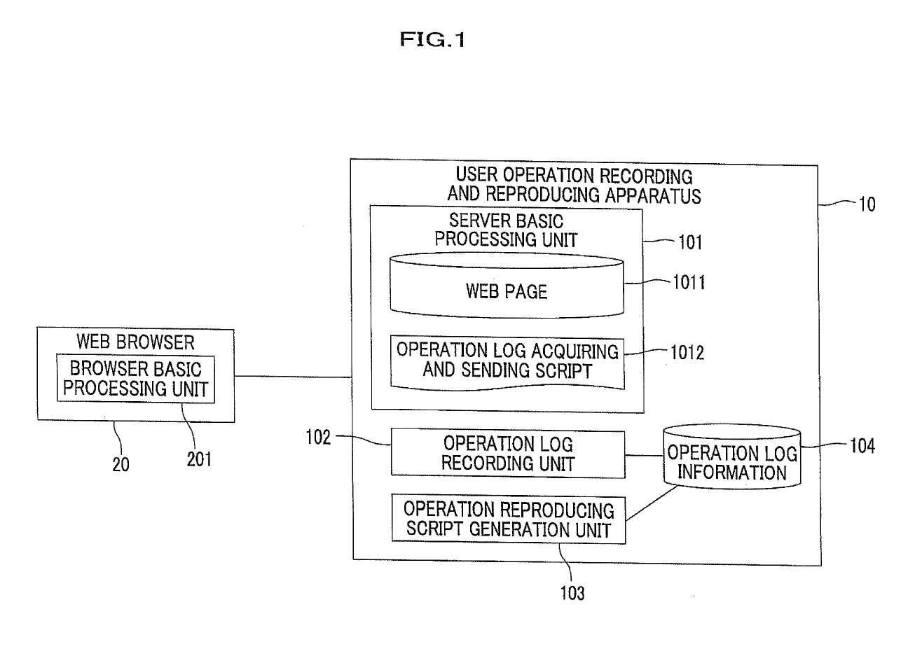

FIG. 1 shows a network system according to an embodiment of the present invention. The network system of the embodiment includes a plurality of information processing apparatuses 10, 20 connected to a network. More specifically, the network system includes the information processing apparatus 10 (hereinafter referred to as “user operation recording and reproducing device” or “server”) which adds a function for recording user operation information and a function for reproducing the recorded user operation to a web page provided in response to a request of a client web browser; and one or more information processing apparatuses 20 (hereinafter referred to as “web browser”) in which a web browser is installed.

The number of the web browsers 20 may be the same as that of users, but only one web browser is shown in FIG. 1 to clarify the description.

Each of these information processing apparatuses 10, 20 includes a general hardware configuration required to execute programs for realizing its functions (a Central Processing Unit (CPU), a memory, a hard disk in which programs are installed, and the like), input devices such as a mouse and a keyboard, and a display device. Each element and function described below is realized by the CPU which executes a predetermined program.

The web browser 20 includes a browser basic processing unit 201 as its operation part. The browser basic processing unit 201 performs processing for displaying a web page on the display device on the basis of a web page received from the user operation recording and reproducing device 10. The browser basic processing unit 201 also performs processing for recording and reproducing a user operation on the basis of a script.

The user operation recording and reproducing device 10 includes a server basic processing unit 101, an operation log recording unit 102 and an operation reproducing script generation unit 103 as its operation part.

The server basic processing unit 101 sends a web page containing a user operation recording function in response to a request from the web browser 20 to acquire the web page containing the user operation recording function. Thus, the server basic processing unit 101 is capable of storing one or more web pages 1011 to be provided and an operation log acquiring and sending script 1012 and sends these to the web browser 20 which requires them. The operation log recording unit 102 receives operation log record information sent from the web browser 20 which loads and displays the web page containing the operation log acquiring and sending function, and records the operation log record information in operation log information 104.

The operation reproducing script generation unit 103 reads a specific operation record from the operation log information 104 and generates a script for reproducing an operation recorded in the specific operation record on a web page related to the specific operation record.

In accordance with the above functional configuration, the user operation recording and reproducing device 10 can perform the user operation recording function and the user operation reproducing function.

The user operation recording function provides a web page 1011A containing a user operation information recording and sending function for causing the web browser 20 to record a user operation made on a web page provided to the web browser 20, to send information on the user operation to the user operation recording and reproducing device 10 in order to record the user operation information in the operation log information 104.

The user operation reproducing function reads information on a specific user operation recorded in the operation log information 104 and generates a script for reproducing the specific user operation recorded in the operation log information 104 on a web page related to the specific user operation information. The user operation reproducing function also provides a web page 1011B related to the specific user operation information and the script for reproducing a generated operation with the web browser 20.

The user operation recording function is further described below.

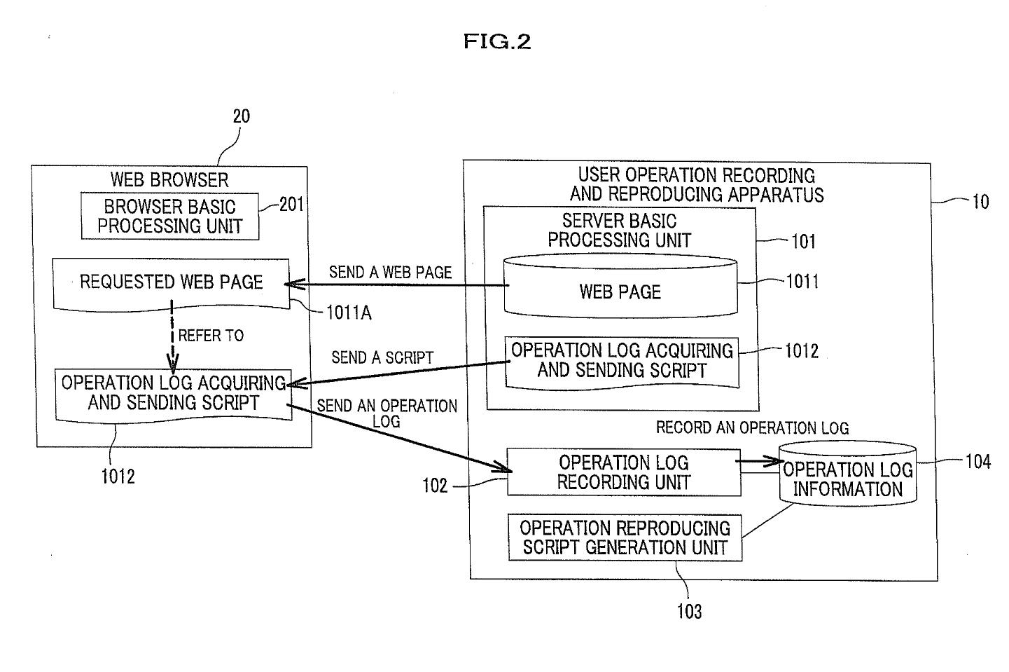

FIG. 2 shows flows of information when the user operation recording function is executed by the user operation recording and reproducing device 10. The web page 1011A containing the user operation recording function, which is provided by the user operation recording function of the user operation recording and reproducing device 10, is written to contain or refer to the operation log acquiring and sending script 1012. It is to be noted that an administrative user who creates the web page 1011A modifies sources of the web page 1011A such that the web page 1011A contains the operation log acquiring and sending script 1012 or refers to the operation log acquiring and sending script 1012.

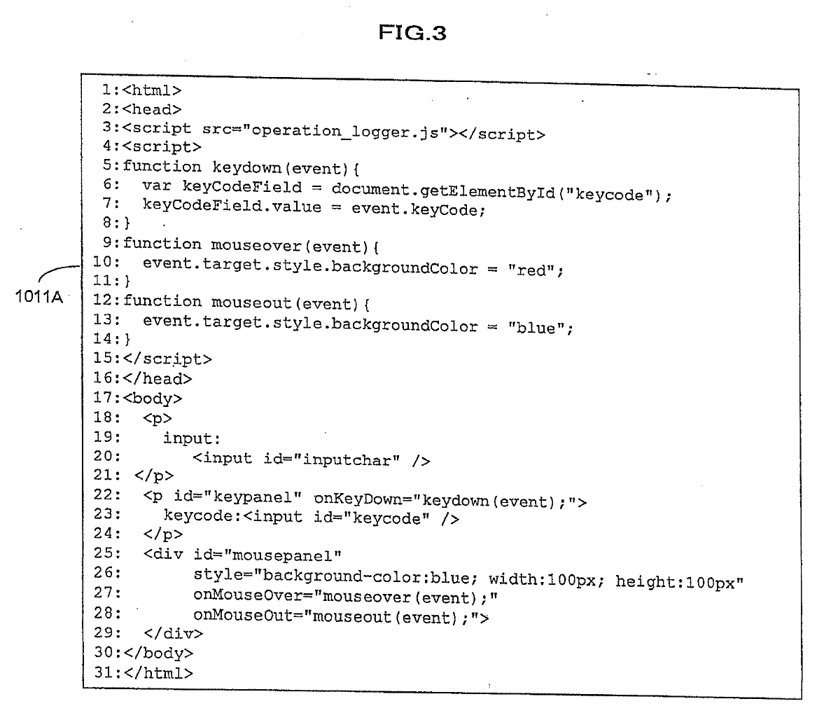

FIG. 3 shows an example of the web page 1011A. In the example, the name of the operation log acquiring and sending script 1012 is “operation-logger.js” and the operation log acquiring and sending script 1012 is written such that the script 1012 is referred to.

Once the server basic processing unit 101 of the user operation recording and reproducing device 10 receives a request from the web browser 20 to acquire a web page containing the user operation recording function, the server basic processing unit 101 sends the web page 1011A and the operation log acquiring and sending script 1012 to the web browser 20.

When the browser basic processing unit 201 receives the web page 1011A and the operation log acquiring and sending script 1012, the browser basic processing unit 201 executes the operation log acquiring and sending script 1012 to record a user operation on the web browser 20 and send the recorded user operation information to the user operation recording and reproducing device 10.

When the operation log recording unit 102 of the user operation recording and reproducing device 10 receives the user operation information, the operation log recording unit 102 records the received user operation information in the operation log information 104.

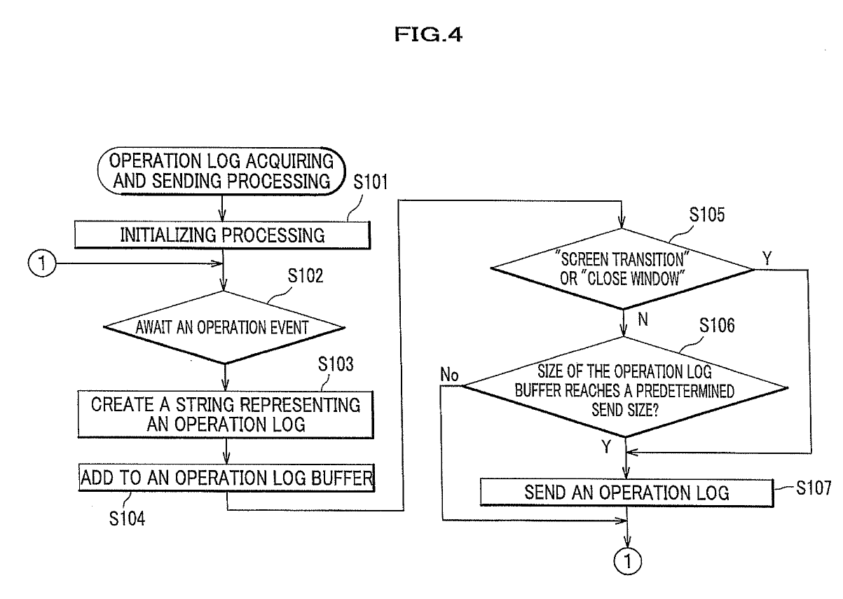

FIG. 4 is a flowchart of user operation recording processing.

When the browser basic processing unit 201 of the web browser 20 reads the web page 1011A, the browser basic processing unit 201 also reads the operation log acquiring and sending script 1012, which is referred to from the source of the web page 1011A, and starts to execute the script 1012. At this time, the following initialization processing (S101) is performed before operation log acquiring and sending processing is executed in accordance with the operation log acquiring and sending script 1012.

At first, the browser basic processing unit 201 modifies an XMLHttpRequest object, which performs the background communication of JavaScript, in accordance with the operation log acquiring and sending script 1012 to further acquire and transmit a content of the background communication as an operation log.

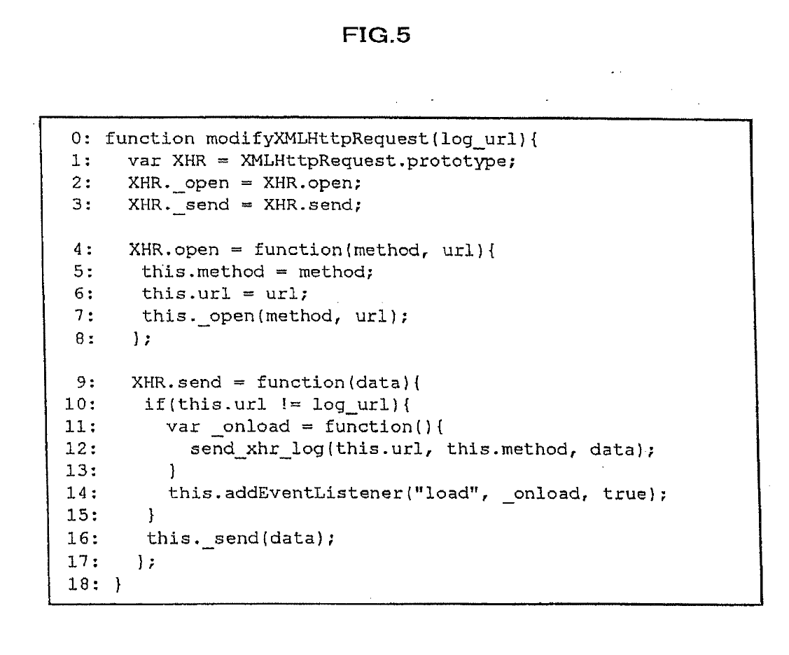

FIG. 5 shows an example of JavaScript describing the XMLHttpRequest object to be modified to further acquire and transmit the communication content of the background communication as the operation log. Line numbers are added to the left end for an explanatory purpose only.

In the XMLHttpRequest object, a destination server and a connection method are specified by the open method, and an Http request is sent to the destination server by the send method. Upon reception of an Http response from the destination server, a method set to be onload attribute is executed.

The browser basic processing unit 201 modifies the send method to record request information as user operation information (line 9 to line 17 in FIG. 5). The send method is also modified to record information regarding onload attribute, which is received from the destination server, as the user operation information (send xhr log function of line 12 in FIG. 5 sends a URL, request information, and response information to the user operation recording and reproducing device 10). Thus, the function to record the content of the background communication can be provided.

The browser basic processing unit 201 further defines an event handler for processing an event to record information on an event generated by a user operation on the web browser 20.

JavaScript can define an event handler for each kind of events and each element in which the event occurs.

Thus, the browser basic processing unit 201 specifies all events which are to be recorded as the kinds of events the event handlers respond to. The browser basic processing unit 201 also specifies a whole web page displayed by a browser as elements where the event occurs. The browser basic processing unit 201 also sets the event handler to perform processing that creates a character string representing information on a generated event and sends the character string to the user operation recording and reproducing device 10 as user operation recording information. The event handler is implemented with methods for the processing S102 and S1103 to be described later.

At last, the browser basic processing unit 201 initializes an operation log buffer for storing recorded user operation information in a memory of the web browser 20 in a certain amount. As an example of the operation log buffer implemented by JavaScript, Array object may be used as the operation log buffer.

Upon completion of the initialization processing, the browser basic processing unit 201 awaits an event generated by a user operation on the web browser 20 (S102).

When a user performs an operation on the web browser 20 and an event corresponding to the operation is generated, the browser basic processing unit 201 executes the event handler set by the initialization processing S101 to create a character string of the event information in accordance with the generated event (S103).

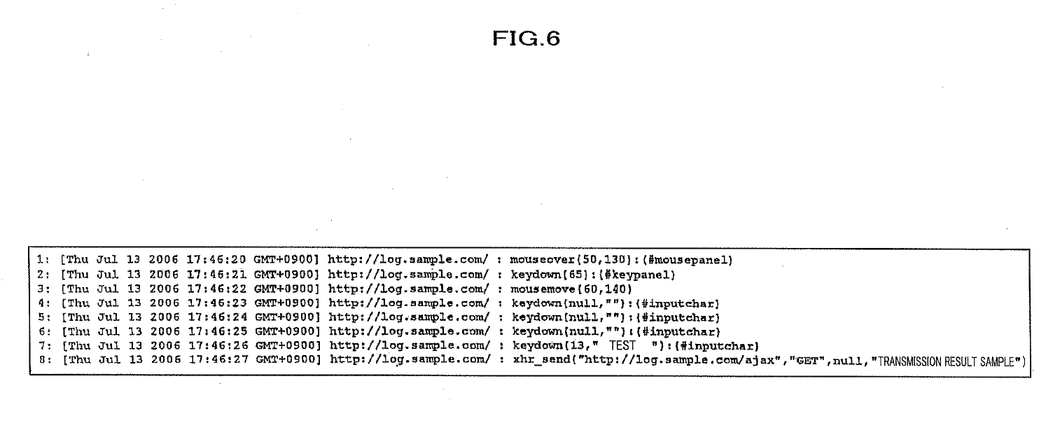

FIG. 6 shows an example of event records which are represented by character strings. Line numbers are added at the left end for the explanatory purpose only.

The character string of line 1 indicates an event where a mouse cursor is placed on a tag element to which an ID “mousepanel” is assigned on a web page of which Uniform Resource Locator (URL) is http://log.sample.com/ at Jul. 13, 2006 17:46:20 in Japan time. The character string of line 1 also indicates that the position of the mouse cursor is (50, 130) in the relative coordinate on the web page when the event occurs as supplementary information.

The character string of line 2 indicates an event where a key of a keyboard is pressed on a tag element to which an ID “keypanel” is assigned. The character string of line 2 also indicates a code of the pressed key is “65” as supplementary information. The character string of line 3 indicates an event where the mouse cursor is moved. The character string of line 3 also indicates as supplementary information the position of the mouse cursor is (60, 140) in the relative coordinate when the movement of the mouse cursor is detected.

The character strings of lines 4 to 7 indicate an event where keys of the keyboard are pressed on a form tag element to which text can be input and an ID “inpuchat” is assigned. In the case of the form tag element to which text can be input, a character string input in the form is recorded in addition to a code of the pressed key as supplementary information, which is different from the case of line 2.

The character string of line 8 indicates an event where background communication processing is performed. The character string of line 8 also indicates as supplementary information that a URL is “http://log.sample.com/ajax”, a method is “GET”, no request data is sent, and a response data is “TRANSMISSION RESULT SAMPLE” when a Hyper Text Transfer Protocol (HTTP) communication is carried out.

As shown in the example of FIG. 6, the browser basic processing unit 201 creates a character string representing information on a generated event such that the character string indicates time when an event occurred, the URL of a web page where the event occurred, the kind of the event, a target element of the event, and the supplementary information of the event.

As supplementary information, the browser basic processing unit 201 records a position of a mouse cursor in a case of an event which is related to the operation of the mouse cursor; and information on an operated key and information on a character string input in a target form (INPUT tag element or TEXTAREA tag element) in a case of an event which is related to the operation of the keyboard.

The browser basic processing unit 201 records a destination URL, an HTTP communication method, request information, and response information as the supplementary information when the background communication occurs.

Generally, information on a character string input in a target form does not have to be recorded as supplementary information for an event related to the operation of the keyboard so long as information on the operated key is recorded. However, in a case where a character input operation is performed on the web browser 20 by means of an input program corresponding to a language a user uses, such as an input program for Japanese, which is provided by an operating system executing the web browser 20, the information on the operated key may not be obtained accurately. Thus, as shown in FIG. 6, the browser basic processing unit 201 records information on the character string input in the target form, whereby the character string the user has actually input can be accurately recorded.

Next, the browser basic processing unit 201 adds an operation log character string generated in S103 to the operation log buffer (S104).

Then, the browser basic processing unit 201 determines whether a generated event is an event representing “screen transition” or “exit a window” (S105). If the generated event is determined to be the event representing “screen transition” or “exit a window” (Y in S105), processing proceeds to operation log sending processing (S107), which will be described later. The event representing “screen transition” or “exit a window” is an event representing a link jump, a send button, a return button, a next button, and reload (reread or update).

On the other hand, if the generated event is determined not to be the event representing “screen transition” or “exit a window” (N in S105), the browser basic processing unit 201 checks whether a size of the operation log buffer after the character string is added is within a predetermined sending size (S106). The sending size may be set arbitrarily, which means that if the sending size is set to be small, a small amount of operation log character strings is sent to the user operation recording and reproducing device 10 frequently, and if the sending size is set to be large, a large amount of operation log character strings is sent to the user operation recording and reproducing device 10 in a long sending interval. The sending size of the operation log buffer may be changed as appropriate in consideration of a load circumstance of a network to be implemented.

If the size of the operation log buffer is smaller than the sending size (N in S106), the processing of the browser basic processing unit 201 returns to the processing at S102.

On the other hand, if the size of the operation log buffer reaches the sending size (Y at S106), the processing of the browser basic processing unit 201 proceeds to the operation log sending processing (S107).

In S107, the browser basic processing unit 201 sends all operation log character strings accumulated in the operation log buffer to the user operation recording and reproducing device 10. After that, the browser basic processing unit 201 initializes the operation log buffer and the processing returns to the processing at S102.

The description on the user operation recording processing has been made above.

The user operation reproducing function will be now described.

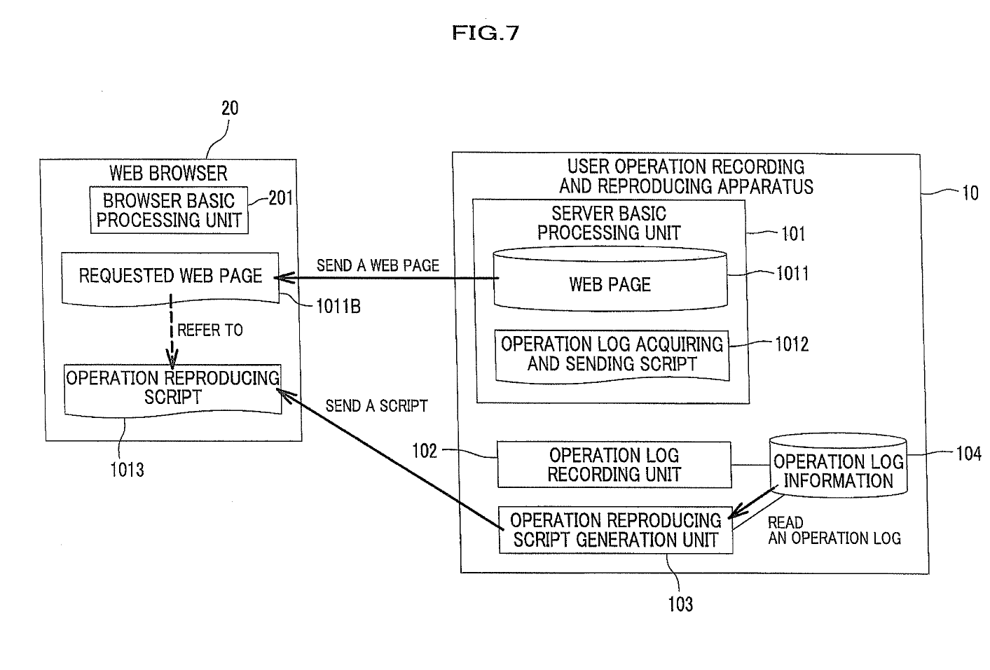

FIG. 7 shows the user operation reproducing function.

A web page 1011B containing the user operation reproducing function, which is provided by the user operation reproducing function of the user operation recording and reproducing device 10, is written to contain or refer to an operation reproducing script 1031 generated by the operation reproducing script generation unit 103. It is to be noted that an administrative user who creates the web page 1011B modifies sources of the web page 1011B such that the web page 1011B contains the operation reproducing script 1012 or refers to the operation reproducing script 1012.

The operation reproducing script generation unit 103 of the user operation recording and reproducing device 10 extracts an operation log to be reproduced from the operation log information 104 in advance, and then generates the operation reproducing script 1031 which reproduces the extracted operation log.

Processing for generating the operation reproducing script 1031 is executed when the operation log to be reproduced is specified by the administrative user of the user operation recording and reproducing device 10 from the information stored in the operation log information 104.

If a user ID of an operator and a session ID are also recorded at the same time as information to be recorded in the operation log information 104, it is easy to identify the operator of a web page on which the operator performs an operation. In general, the user ID and the session ID are managed by a web application which provides a web page in most cases. Therefore, if the user ID and the session ID are to be recorded in the operation log information 104, the information need to be obtained from the web application. Although the user ID and the session ID are generally obtained by using a cookie function of the web browser 20 in most cases, the implementation methods may vary. Descriptions on specific implementation methods are omitted in this specification.

Upon receipt of a request from the web browser 20 for acquiring the web page 1011B containing the user operation reproducing function, the server basic processing unit 101 sends the web page 1011B and the operation reproducing script 1031 to the web browser 20.

When the browser basic processing unit 201 receives the web page 1011B and the operation reproducing script 1031, the browser basic processing unit 201 executes the operation reproducing script 1031 to perform processing for reproducing a specific user operation accumulated in the operation log information 104.

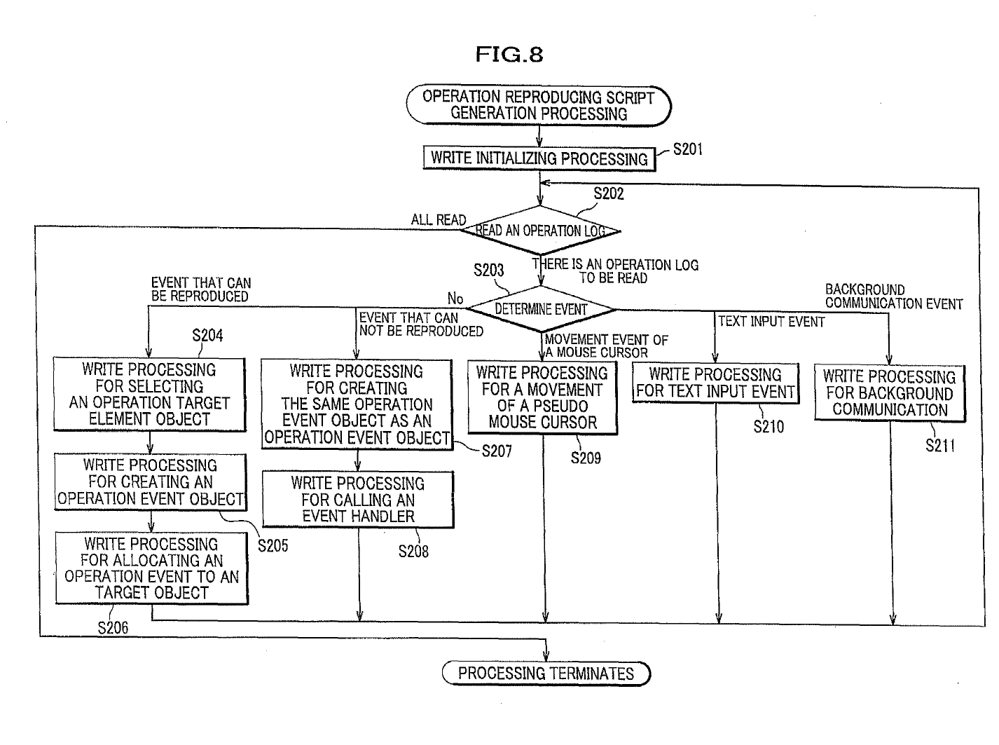

The processing for generating the operation reproducing script 1031 which incorporates the user operation reproducing function provided by the user operation recording and reproducing device 10 into the web page 1011B will be now described with reference to a flow shown in FIG. 8.

Processing for reproducing the specified record in the user operation information accumulated in the operation log information 104 after initializing processing is written in the operation reproducing script 1031.

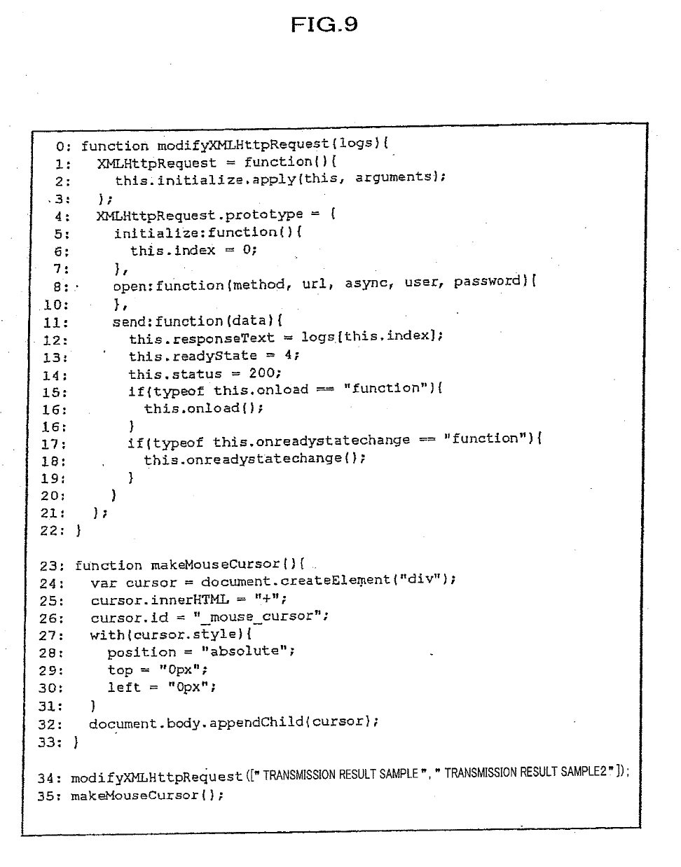

FIG. 9 is an example of JavaScript which performs the initializing processing. Line numbers are added to the left end for the explanatory purpose only.

The operation reproducing script generation unit 103 writes the operation reproducing script 1031 such that processing for modifying XMLHttpRequest to reproduce background communication processing and processing for displaying a pseudo mouse cursor are performed as the initializing processing (S201).

At first, the operation reproducing script generation unit 103 modifies the XMLHttpRequest object which provides the background communication function with JavaScript (lines 0 to 22 in FIG. 9) and overwrites that a communication with a sever is not performed and the communication information stored in the operation log information 104 is reproduced. More specifically, the operation reproducing script generation unit 103 overwrites the send method so that the HTTP communication is not performed, the information stored in the operation log information 104 is set as response information from a server, and methods set as onload attributes are executed (lines 0 to 22 in FIG. 9). The background communication recorded in the operation log information 104 can be reproduced by the above modification.

The operation reproducing script generation unit 103 also writes the script so that an element which represents a pseudo mouse cursor (an IMG tag indicating an image when an image which imitates a mouse cursor is used or a DIV tag indicating a simple square or a character string, e.g. “+” when these elements are used) is displayed on the web page 1011B which is displayed by the web browser 20.

The script on Lines 23 to 33 in the example of the initializing processing shown in FIG. 9 indicates processing that displays “+” on the web browser 20 as the pseudo mouse cursor. Although a function of reproducing a mouse cursor movement event is provided with an execution environment of JavaScript as its specification, which is included in most of the web browsers, a function of moving a real mouse cursor used by a user is not realized by the execution environment of JavaScript. Therefore, the above pseudo mouse cursors are used to reproduce the movement operation of the mouse cursor.

Next, the operation reproducing script generation unit 103 reads a record specified by the administrative user from the operation log information 104 (S202 in FIG. 8). At this time, if all user operation information specified by the administrative user which is accumulated in the operation log information 104 has been read, this flow (the processing for generating the operation reproducing script) is terminated. On the other hand, if user operation information not yet read is read, the kind of an event which is recorded in the operation information is determined (S203), and then the operation reproducing script corresponding to the kind of the event is generated.

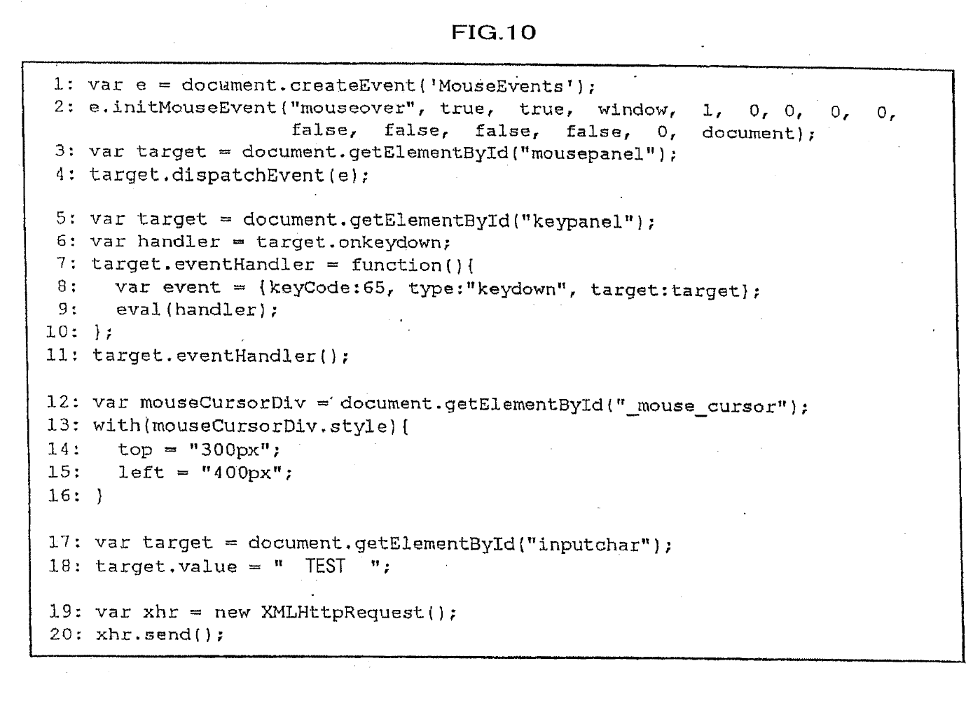

FIG. 10 shows an example of a script which describes reproducing processing of events. Methods for generating each reproducing script which corresponds to each kind of events are now described in detail.

A reproducing script is generated as described below in a case where an event can be reproduced by a JavaScript function (S204 to S206 in FIG. 8). Events that can be reproduced by the JavaScript function are a mouseover event, a mouseout event, and the like.

At first, the operation reproducing script generation unit 103 writes processing for acquiring an event target as an operation target element object of an event (S204). In order to acquire the event target, a getElementById method and getElementsByTagName method of Document object JavaScript provides as its basic function are used. The getElementById method specifies an ID and acquires a tag element having the same value as the specified ID as the value of an ID attribute. The getElementsByTagName method specifies a tag name and acquires all tags whose tag names are the same as the specified tag name. When the ID is included in user operation information as target element information, the getElementById method is used to acquire the target element. When the ID is not included and only tag name and the number indicating in which number the tag appears (hereinafter referred to as a tag number) are included, all tags whose tag names are the same are acquired, and then, a tag whose tag number is the same is acquired as the target element from all the tags whose tag names are the same.

Next, the operation reproducing script generation unit 103 writes processing for creating an event by using an event creation function provided by JavaScript as its basic function (S205).

A function of creating an event, which is a createEvent method, is prepared in Document object. Further, event information setting functions such as an initMouseEvent method and initUIEvent method are prepared in an Event object, which is created by using the createEvent method. The event can be created by using these methods.

The operation reproducing script generation unit 103 then writes processing for creating the event which is created by the operation event object creation processing written in S204 to S211 on the target element acquired by the operation target object acquiring processing written in S204 (S206). The event can be created when a dispathEvent method of the target element is called with the event as its argument.

The script on lines 1 to 4 in FIG. 10 indicates processing for reproducing an event where a mouse cursor is moved to a tag element of which ID is “mousepanel”. A mouse event is created by the createEvent method (line 1 in FIG. 10) and then initialized as an event “mouseover” which indicates that a mouse cursor is placed on a tag element (line 2 in FIG. 10), a tag element whose ID is “mousepanel” is acquired (line 3 in FIG. 10), and the created mouse event is allocated on the acquired tag element by dispathEvent method to realize reproduction of the mouse event.

A reproducing script is generated as described below in a case where an event can not be reproduced by a JavaScript function (S207 to S208 in FIG. 8).

An execution environment of JavaScript, which is included in most of the web browsers, does not provide a function of reproducing a keyboard event as its basic function. Thus, the operation reproducing script generation unit 103 writes processing for creating an object which has the same information as a keyboard event (hereinafter referred to as a substitute keyboard event object) as an event object (S207), and calling an event handler corresponding to the keyboard event with the created substitute keyboard event as an argument (S208).

The processing for creating the substitute keyboard event object is realized by processing for creating an object whose event type and key code information are “type” attribute and “keyCode” attribute respectively. The processing for calling the event handler is realized by processing for acquiring an event handler which is set in an event target element recorded in user operation information by analyzing a web page, and calling a method of the acquired event handler with the substitute keyboard event object created by processing written in the step S207 as its argument.

An event handler is acquired by the following analysis processing. Generally, a keyboard event in JavaScript is processed from a target element to a tag element in upper hierarchy sequentially, and all event handlers set in the target element to the tag element in the top hierarchy including intervening tag elements are executed. Therefore, the target element to the tag element in the top hierarchy are analyzed sequentially and all scripts set as keyboard event handlers which are set in these tag elements are acquired.

The script on the lines 5 to 11 in FIG. 10 indicates processing for reproducing an event where a key “a” is pressed on a tag element whose ID is “keypanel”. The processing for reproducing the key event is realized by acquiring the tag element whose ID is “keypanel” (line 5 in FIG. 10. it is analyzed that an event handler is set only on the tag element “keypanel” in this example.), acquiring an event handler set in the tag element (line 6 in FIG. 10), creating the same object as the key event (line 8 in FIG. 10), and calling the acquired event handler (line 11 in FIG. 10).

A reproducing script is generated as described below in a case of an event related to a mouse cursor movement (S209 in FIG. 8).

In this case, the operation reproducing script generation unit 103 writes processing for moving a pseudo mouse cursor created by the initializing processing S201.

Movement of an element is realized by changing an attribute value of Cascading Style Sheet (CSS) of an element, which is supported by JavaScript. More specifically, a value of position attribute is set to be “absolute” and then a value of top attribute (a position relative to the top end of web browser window) and value of left attribute (a position relative to the left end of the web browser window) are set. The script on lines 12 to 16 indicates processing for reproducing an event of a mouse cursor movement. The script on line 12 in FIG. 10A indicates that a tag element representing a pseudo mouse cursor is acquired (a tag element whose ID is “_mouse_cursor” is acquired because an ID of a tag representing the pseudo mouse cursor is set to be “_mouse_cursor” in line 26 in the example of the initializing processing script for reproducing processing shown in FIG. 9). The script on lines 13 to 16 in FIG. 10 indicates that the position of the mouse cursor is set to be (300px, 400px). The processing for reproducing the event of the mouse cursor movement is realized as described above.

A reproducing script is generated as described below in a case where an event is related to a keyboard operation in an INPUT tag whose TYPE attribute is “TEXT” or a TEXTAREA tag (hereinafter the two tags are referred to as a text input format) (S210 in FIG. 8).

In this case, the operation reproducing script generation unit 103 writes processing for setting a value of an input character string recorded in user operation information on an event in a text input form which is a target of the event. More specifically, the operation reproducing script generation unit 103 writes the same processing as the processing for acquiring an operation target object shown in S204. Then, the operation reproducing script generation unit 103 writes processing for setting the value of the input character string recorded in the user operation information on the event as a value of value attribute of the acquired operation target object.

The script on lines 17 to 18 in FIG. 10 indicates processing for reproducing an operation of inputting a character string in a text input form. The script on line 17 in FIG. 10 indicates processing for acquiring a tag element which is an input target. The script on line 18 in FIG. 10 indicates processing for setting a value of the tag element as “TEST” (it is assumed that an operation log representing that the character string “TEST” is input by a Japanese input program.) The processing for reproducing the operation of inputting the character string in the text input form is thus realized.

A reproducing script is generated as described below in a case where an event is related to background communication (S211 in FIG. 8).

In this case, the operation reproducing script generation unit 103 writes processing, which has been modified by the initializing processing described in S201, where a communication with a server is not carried out, response information from the server is set, and then the send method of XMLHttpRequest which executes methods set as onload attributes is called. The response information from the server recorded in the user operation information in the operation log information 104 is used to write the processing for setting the response information from the server. The response information can be set by writing “this.responseText=‘(response information recorded)’;” in the send method to be modified.

The script on lines 19 to 20 in FIG. 10 indicates processing for reproducing background communication. The script on line 19 in FIG. 10 indicates processing for creating XMLHttpRequest object which is modified in the initializing processing to perform reproduction processing based on the operation log information 104. The script on line 20 in FIG. 10 indicates processing for calling the send method. The processing for reproducing the background communication is realized as described above. In accordance with the modification made on the XMLHttpRequest object shown in lines 11 to 20 in the example of the initializing processing script for reproduction processing shown in FIG. 9, the processing is performed where the background communication is not performed, and response information, which is a result of the background communication recorded in the operation log information 104, is reflected.

The processing of operation reproducing script generation unit 103 returns to S202 and the operation reproducing script generation unit 103 continues processing after the processing in S206, S208, S209, S210 and S211 are completed.

The processing for generating the operation reproducing script 1031 has been described as above.

A user operation is reproduced on the web browser 20 by the operation reproducing script 1031 created as described above.

The description has been made on the embodiment of the present invention above.

In accordance with this embodiment, the administrative user of the user operation recording and reproducing device 10 can record a user operation on a web page whose target is a user, which is performed by the web browser 20 without making the user to notice that he or she uses the function.

A user operation can be reproduced on a web browser on the basis of user operation information recorded in the user operation recording and reproducing device 10.

In accordance with this embodiment, there is provided the function of recording and reproducing a user operation that is capable of reproducing a user operation which is related to an event not supported by JavaScript for reproduction without installation of dedicated software other than a web browser in a user's system environment.

There is also provided the function of recording and reproducing the background communication, which reproduces recorded communication contents as they are without performing a communication with a destination server during reproducing processing.

In accordance with these functions provided by this embodiment, it is possible to record an operation performed by a web browser in detail without making a user to notice he or she uses the function. It is also possible for the administrative user to reproduce the recorded user operation in detail. The administrative user and developers can understand behaviors of the user on a web page and utilize the information for improving usability of the web page.

The present invention is not limited to the above embodiment, and various modifications of the above embodiment are possible.

The operation log acquiring and sending script 1012 is installed in the web server basic processing unit 101 in the above embodiment. However, the operation log acquiring and sending script 1012 can be installed in other web servers which are different from the user operation recording and reproducing device 10 because JavaScript can be executed in any server regardless of a place where the server is disposed as long as a web browser can access the server.

The web server basic processing unit 101 is also installed in the information processing apparatus which realizes the user operation recording and reproducing device 10 in the above embodiment, however, the web server basic processing unit 101 may be installed in an independent information apparatus. It is to be noted that the web server basic processing unit 101 and the user operation recording and reproducing device 10 have to be accessed by the same URL domain from the web browser 20 in this configuration because the background communication function of JavaScript implemented in most of web browsers only allows access to the same domain as that of the URL of the web page the web browser 20 is referring to.

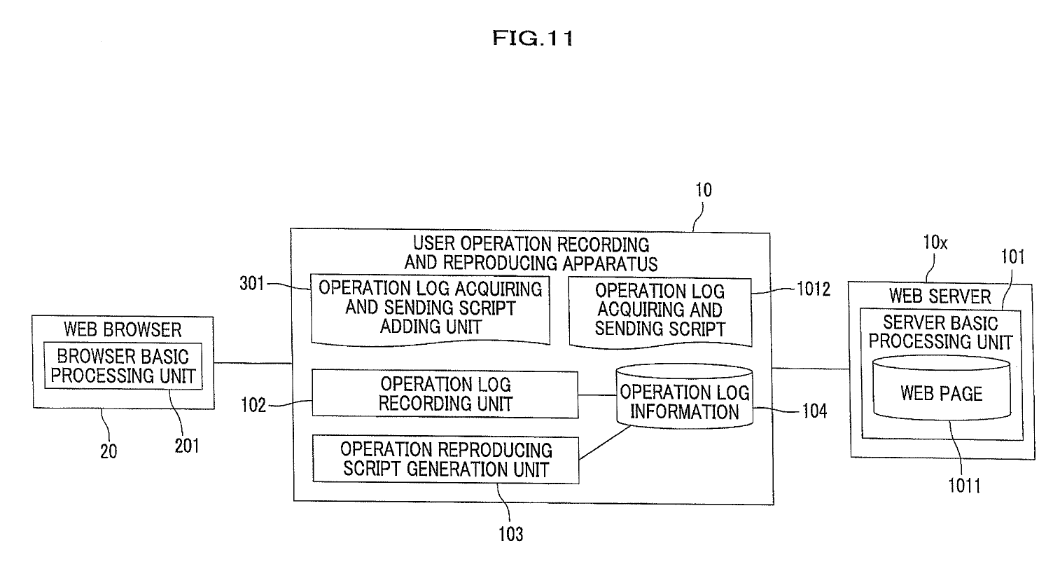

An independent web server 10x including the web server basic processing unit 101 may be arranged as shown in an example of a system configuration in FIG. 11 as another configuration. The user operation recording and reproducing device 10 may be disposed between the web browser 20 and the web server 10x as a proxy server which includes other main function units.

It has been described that the administrative user writes the web page 1011A such that the web browser refers to the operation log acquiring and sending script 1012 in the above embodiment, however, processing which inserts a statement that makes the web browser to refer to the operation log acquiring and sending script 1012 may be performed at the proxy server.

In the example of the system configuration in FIG. 11, an operation log acquiring and sending script adding unit 301 is further included in the user operation recording and reproducing device 10. The operation log acquiring and sending script adding unit 301 has functions of acquiring a web page requested by the web browser 20 from the server basic processing unit 101 which stores the web page, and inserting the operation log acquiring and sending script 1012 into the acquired web page, and then sending the web page to the web browser 20.

In accordance with this configuration, it is possible to automatically insert into a web page a statement that the operation log acquiring and sending script 1012 is referred to without the need for the administrative user to write the statement that the operation log acquiring and sending script 1012 is referred to. Thus, the recording function of user operation information can be readily provided with a number of web pages. It is to be noted that the user operation recording and reproducing device 10 and the server basic processing unit 101 have to be arranged such that both of them are accessed by the same URL domain from the web browser 20 in this configuration.

The description has been made on the case where the administrative user of the user operation recording and reproducing device 10 specifies the operation log information 104 and makes the operation reproducing script generation unit 103 to generate the operation reproducing script 1031 in the above embodiment. However, the present invention is not limited to the above embodiment, and the operation log information 104 to be reproduced may be specified based on request information from the web browser 20 and then makes the operation reproducing script generation unit 103 to generate the operation reproducing script 1031. For example, an embodiment may be such that user operation information to be reproduced is extracted based on information contained in request information, which specifies the operation log information 104 (a user ID, a session ID, operation reproduction start time, operation reproduction finish time, and the like) when the user operation recording and reproducing device 10 receives a request from the web browser 20, which is different from the case where the operation reproducing script 1031 is generated in advance. Then, the operation log reproducing script 1031 is generated in accordance with the flow for generating the operation log reproducing script 1031 shown in FIG. 8. After that, the statement that the generated operation log reproducing script 1031 is referred to is inserted in the web page and then the web page is sent to the web browser 20. In accordance with the function performing the processing described above, the above methods can be realized.

In accordance with the above configuration and methods, the administrative user does not have to generate the operation log reproducing script 1031 in advance, and a user of the user operation reproducing function is able to use the user operation reproducing function by specifying user operation information recorded in the operation log information 104 directly.

Thus, the embodiment and its modification of the present invention have been described above.

web applications have been used for most of office work systems in corporations. High usability web applications, which utilize a background communication function of JavaScript and do not create window transition, have become commonly used. As the high usability web applications are commonly used the web applications are further required to improve their usability.

In view of the above circumstances, developers of web applications are required to improve the web applications as appropriate to provide high usability web applications which meet the requirement of users.

The present invention provides a system environment which is capable of recording operation information of a user on a web browser without making the user to notice that he or she is using the function. By analyzing operation information of the user which is collected by the present invention, and reproducing the user operation by the present invention, it is possible to understand how a web application is used by the user and use the information to improve the usability of the web application.

What is claimed is:

1. A method of recording a user operation on a web browser coupled to a web server comprising the steps of:
recording information on an event generated by the user operation on the web browser at the web browser;
transmitting the recorded information on the event to the web server using a background communication function of a script the web server generates and the web browser reads at the web browser, and
recording the received information on the event at the web server.

2. The method according to claim 1, further comprising the step of modifying an object for providing the background communication function so as to record a content of the background communication and send the recorded communication content to the web server using the background communication function of the script in the script the web browser reads.

3. The method according to claim 1, further comprising the steps of:
recording a character string input in a text input form together with event information; and
transmitting the recorded information to the web server using the background communication function of the script by the script the web browser reads when an event is generated by a keyboard operation in the text input form.

4. A method of reproducing a user operation provided by a web server, comprising the steps of:
generating a script for reproducing a record of a user operation performed by a web browser on a web page and a user operation performed by the web browser on the web page which is recorded in the record of the user operation on the basis of the web page at the web server;
sending the generated script to the web browser at the web server, and
receiving the script and executing the received script to reproduce the user operation performed by the web browser on the web page at the web browser.

5. The method according to claim 4, comprising the steps of:
analyzing the web page to obtain an event handler corresponding to an element of an operation target;
creating an object containing the same information as an event object corresponding to a keyboard operation, and
passing the created object to the obtained event handler to reproduce an event generated by the keyboard operation by the script generated by the web server and read by the web browser.

6. The method according to claim 4, further comprising the step of displaying a pseudo mouse cursor on the web browser when a movement of a mouse cursor is reproduced by the script generated by the web server and read by the web browser.

7. The method according to claim 4, further comprising the step of setting a character string input in a text input form which is recorded as a record of the keyboard operation as an input character string in the text input form when the keyboard operation in the text input form is reproduced by the script generated by the web server and read by the web browser.

8. The method according to claim 4, further comprising the step of modifying an object for a background communication so as to process a content of the background communication recorded in a record of a user operation as a result of communication process when the background communication process is reproduced by the script generated by the web server and read by the web browser.

9. A user operation recording system comprising a web server and a web browser coupled to the web server for recording a user operation on a web browser, wherein the web browser records information on an event generated by a user operation on the web browser and sends the recorded information on the event to the web server by means of a background communication function of a script the web browser reads, and
the web server records the information on the event received from the web browser.

10. A user operation reproducing system comprising a web browser and a web server, the user operation reproducing system reproducing a user operation on the web browser, wherein the web server generates a script for reproducing a record of a user operation performed by the web browser on a web page and a user operation performed by the web browser on the web page which is recorded in the record of the user operation based on the web page and sends the generated script to the web browser, and
the web browser receives the script and then executes the received script to reproduce the user operation performed by the web browser on the web page.
